(19) United States
(12) Patent Application Publication
(10) Pub. No.: US 2005/0268665 A1
(43) Pub. Date: Dec. 8, 2005

(54) Glass fiber forming and support tube

(75) Inventors: Ismael A. Hernandez, Florence, SC (US); Lee A. Roebuck, Burleson, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 10/863,422

(22) Filed: Jun. 8, 2004

(51) Int. Cl. C03B 37/03

(52) U.S. Cl. 65/539

(57) ABSTRACT

A forming tube for supporting glass fiber is disclosed that includes an elongate tube having opposing ends, an outer surface adapted to have glass fiber wound thereon, and an inner surface, the tube defining a central opening extending along a longitudinal axis of the tube for receiving a mandrel, the tube further defining an opening extending between the inner and outer surfaces thereof and located proximate one of the opposing ends, the opening designed to facilitate access to a start-up portion of the glass fiber from at least the central opening of the tube.

### BACKGROUND OF THE INVENTION

The present invention generally relates to processes for forming, collecting, and unwinding of glass fiber, and more particularly to forming tubes for use in forming, storing, and collecting such fibers. In general terms, the process for producing glass fiber includes heating raw materials into a molten glass and directing the molten glass through orifices and bushings to form hundreds of tiny filaments that are attenuated, cooled, and gathered to form strands. A strand is wound around a rotating cylindrical tube that is mounted on a rotating cylinder or mandrel, which is also known in the art as a collet. The rotating tube is known as a forming tube and supplies tension to the fibers to wind the fibers into a package that is also known in the art as a glass cake. After the winding is complete, the glass fiber cake is further processed, and then the forming tube is collapsed and extracted from the interior of the cake so that the strand can be unwound by grasping the interior end or transfer tail.

One of the difficulties in processing the glass fiber cake is that the transfer tail is often difficult to locate. It is known that a transfer tail can be included in the initial wraps of the glass fiber about the forming tube, which can be located and tied to the outer end of glass fiber on an adjacent glass fiber cake. Therefore, the transfer tail of one glass fiber cake and the connected outer end of glass fiber on an adjacent provide an uninterrupted flow of glass fiber from one glass fiber cake to another.

However, the transfer tail is often lost when the forming tubes are collapsed and removed from the inside of the glass fiber cake. In order to locate the transfer tail of a particular cake, several layers or wraps of the glass fiber must be removed, which creates unnecessary material waste and requires extra time. In addition, the glass fiber may be damaged by the removal of several layers of glass fiber, which is typically performed by a fingernail, hook device, or other sharp tool. As such, there is a need for capturing the transfer tail of a fiberglass cake that is efficient and avoids damaging the cake. There is also a need for removing a tube from a glass fiber cake that consolidates removal of the forming tube while locating the transfer tail of the glass fiber.

### SUMMARY OF THE INVENTION

These and other needs are addressed by a collapsible core or forming tube for supporting glass fiber according to the presently claimed invention. Advantageously, the forming tube defines an opening for locating and accessing glass fiber that is wound about the tube that enables the tube to be removed from the glass fiber while accessing and trapping the glass fiber through the opening, thereby increasing productivity and decreasing waste.

More particularly, the forming tube for supporting glass fiber according to one embodiment comprises a hollow, elongate tube having opposing ends with an outer surface designed to receive the glass fiber, which is wound about the tube to form a glass fiber cake having a start-up portion. The tube defines a central opening that extends along a longitudinal axis of the tube and is designed to receive a mandrel. The tube can be formed from a variety of materials, such as paperboard, polymeric materials, and metallic materials. The tube further defines an opening that extends through the inner and outer surfaces of the tube and is located proximate one of the opposing ends. The opening is designed to facilitate access to a start-up portion of the glass fiber from at least the central opening of the tube.

The opening may be positioned in various ways. More specifically, the opening may be positioned inwardly from one of the opposing ends. The opening may also begin at one of the opposing ends, e.g., a notch or half circle that is open at the end of the tube, and extend along the longitudinal axis toward the other end. It is also possible that the tube defines at least one opening at each of the opposing ends.

Methods of removing the tube from the glass fiber cake are also provided. One method includes the steps of accessing a start-up portion of glass fiber of the glass fiber cake through an opening located proximate one end of the tube. The start-up portion is captured by extending a tool radially outwardly through the opening. The tube is then removed from the glass fiber cake so that the start-up portion is spaced from the glass fiber cake and thereby readily identifiable. To assist with removal of the tube from the glass fiber cake, at least a portion of the tube may be collapsed. One method also includes pushing or pulling the start-up portion through the opening and holding the start-up portion in place while removing the tube. Accordingly, the end of the glass fiber is then available to an operator for connecting with another glass fiber, such as a glass fiber associated with an adjacent glass fiber cake.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic view of a manufacturing operation for making glass fiber and the like according to one embodiment of the present invention;

FIG. 2 is a perspective view of a glass fiber cake according to one embodiment of the present invention;

FIGS. 3a-3d are perspective views of forming tubes according to the present invention;

FIGS. 4a-4b are partial perspective views of a forming tube and glass fiber cake according to the present invention;

FIG. 5 is a partial, cut-away perspective view of a forming tube with glass fiber according to one embodiment of the present invention;

FIG. 6 is a partial, cut-away perspective view of a forming tube with glass fiber according to one embodiment of the present invention; and

FIGS. 7-10 illustrate a method of removing a forming tube from a glass fiber cake according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

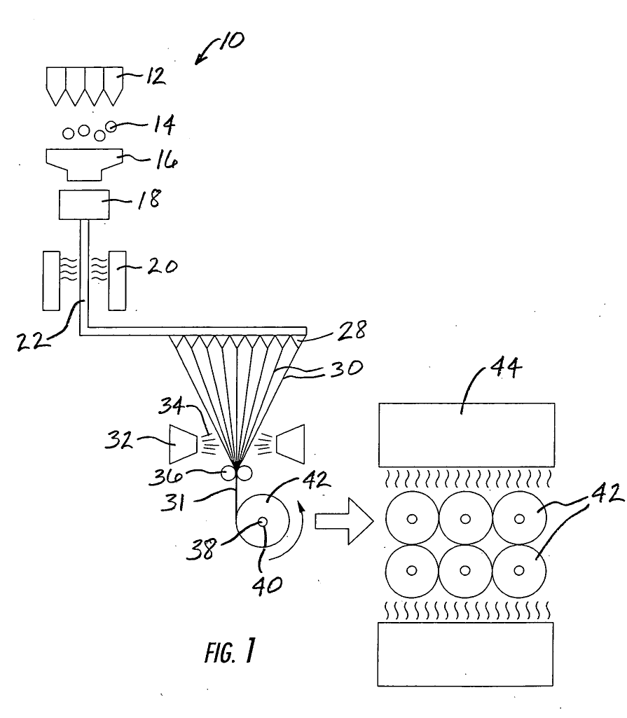

Turning now to the figures, FIG. 1 illustrates a schematic view of a manufacturing operation for making glass fiber and the like according to one embodiment of the present invention. The manufacturing operation 10 includes one or more batch material hoppers 12 for receiving raw materials or batch ingredients 14, which can include SiO₂, Al₂O₃, CaO, MgO, and B₂O₃. The hoppers 12 release a predetermined mixture of raw materials 14 into a blender 16 to create a more homogenous mass of particles. The raw materials 14 are then directed to a furnace 18 where the materials are reduced to molten glass. The furnace 18 can be one of many types that are known in the art and is capable of reaching temperatures in excess of 2800° F. Heaters 20 can also be used along the channel 22 to maintain a desired temperature of the molten glass particles.

The molten glass is then directed through a plurality of bushings 28 that contain hundreds of tiny orifices. The molten glass flows through the orifices to form filaments 30 that are attenuated, cooled and gathered together to form strands. In particular, the filaments 30 are directed toward a nip 36 that may also include a twist or other such procedure to form a strand 31. In one embodiment, a binder applicator or other chemical treatment device 32 applies a chemical 34, such as sizing or a binder agent, to the filaments 30 to coat the filaments and reduce filament breakage during subsequent processing steps, such as twisting. The glass fiber or strand 31 is then directed to a take-up roll, which is preferably a cylindrical tube or mandrel 38 that is also known in the art as a collet. A forming tube 40 is positioned on the cylindrical mandrel 38, which is rotated at high speed such as 2000 to 4000 collet rpm (3000 to 4500 m/min. linear speed) so that the strand 31 is wound about the tube to form a glass fiber pack or cake 42. When a desired length of glass fiber strand 31 is wound about the forming tube 40, the cake 42 (and other glass fiber cakes, if applicable) is then directed to a dryer 44 or the like. Other processes that are known in the art can also be applied, such as twisting, creeling, warping, texturizing, and the like. These processes typically require that the forming tube 40 be removed from the inside of the glass fiber cake 42, as discussed further below.

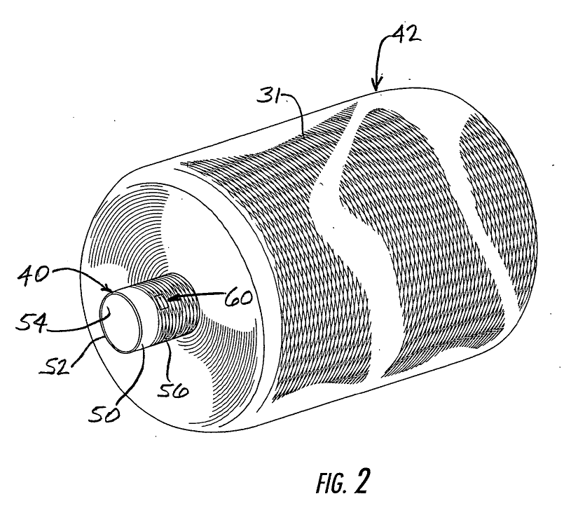

FIG. 2 shows a finished glass fiber cake 42 having a continuous strand of glass fiber 31 wound about the outer surface 50 of the tube 40. The cake 42 is formed by a plurality of initial wraps 56 having a starting end that is eventually connected to the transfer tail of an adjacent tube (not shown). The starting end and initial wraps 56 are initially wrapped around the outer surface 50 of the tube 40 while the tube turns at high speed. When the cake 42 is formed, a transfer tail 46 extends to an adjacent tube (not shown) and connects to that tube's starting end and helps form the initial wraps. As shown in FIG. 2, the forming tube 40 includes an opening 60 that extends through the wall of the tube from the outer surface 50 to the inner surface 54. As shown, the opening 60 is spaced away from an end 52, although this is not a requirement, as discussed below.

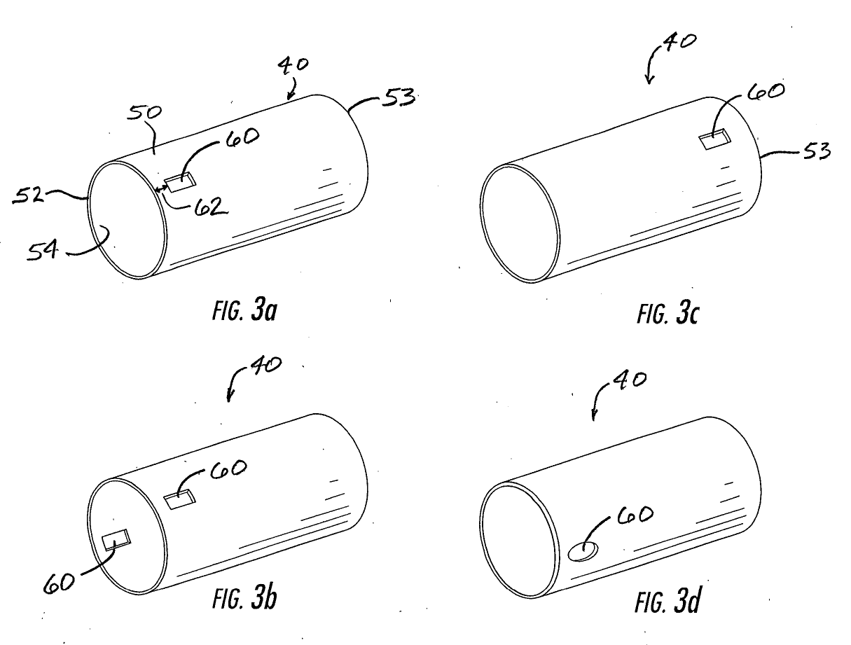

FIGS. 3A-3D illustrate various embodiments of forming tubes and openings according to the present invention. More specifically, FIG. 3A shows a forming tube 40 having a single opening 60 that is spaced from the end 52 to define a gap 62 therebetween. The opening 60 is shown as having a rectangular shape, although other geometric shapes, including but not limited to polygonal, circular, and oval (FIG. 3D), are contemplated by the present invention. FIG. 3B illustrates an alternative embodiment, whereby the forming tube 40 includes a plurality of openings that extend from the outer surface 50 of the tube to the inner surface 54 thereof. In this regard, the term “opening” is given a broad meaning, but preferably is defined as extending through the tube 40 so that objects can be extended through an open space defined by the opening. FIG. 3C illustrates another alternative embodiment, wherein the opening 60 is positioned proximate the opposite end 53. While it is possible that the opening 60 could be spaced anywhere along the length of the tube 40, it is preferable that the opening (or openings) is spaced or located proximate one or both of the ends 52 and 53 of the tube so that glass fiber extending over the opening can be captured, as discussed more fully below.

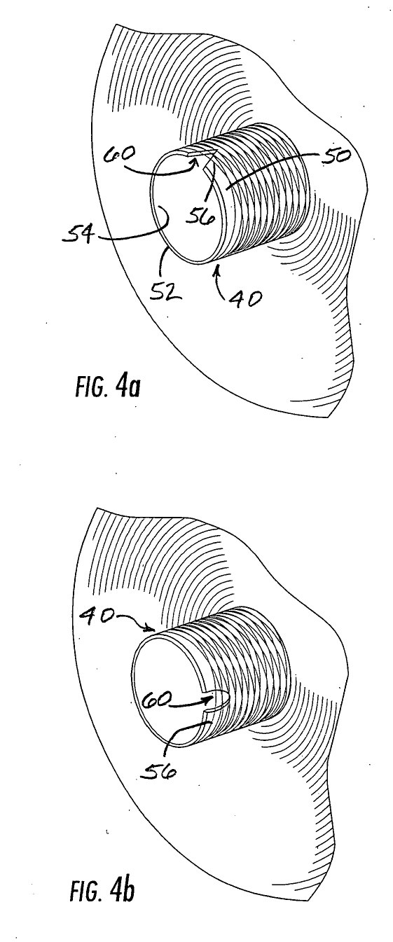

FIGS. 4A-4B illustrate alternative embodiments of the forming tube 40. In particular, FIG. 4A illustrates a partial perspective view of a tube having a plurality of initial wraps 56 wound about the outer surface 50 of the tube 40. The opening 60 is located at the end 52 and has the form of a “V” that opens to the end to form a notch instead of a closed shape that is spaced away from the end 52. FIG. 4B illustrates an alternative embodiment, whereby the opening 60 has a curved shape instead of a “V” shape, and any other notch or shape that “opens” to one or both ends 52 and 53 is contemplated by the present invention. As shown, the initial wraps 56 of the fiber 31 extend over the openings 60 and can be accessed and are visible from the inside surface 54 of the tube 40.

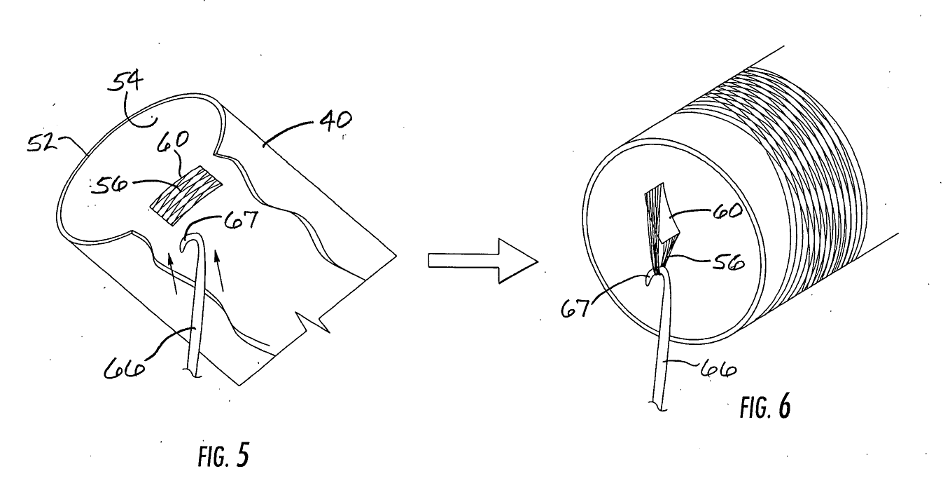

FIGS. 5 and 6 illustrate one method of capturing the initial wraps 56 and preparing the cake 42 for downstream processes. As discussed above, the tube 40 is often removed from the glass fiber cake 42, and in order to reduce fiber waste and improve efficiency, the initial wraps 56 that extend over the opening 60 are captured by a tool 66 having a hook 67 or the like that is extended through the opening to capture the initial wraps. As shown in FIG. 5, the hook 67 of the tool 66 is extended through the opening 60 from the inside surface 54, although it is contemplated that the hook 67 could be extended through the opening from the outer surface 50 to the inner surface 54. FIG. 6 shows the initial wraps 56 being pulled in a radial and/or longitudinal direction through the opening 60 by pulling the tool 66 so that the initial wraps are captured and pulled by the hook 67. Because the initial wraps 56 are preferably one of the initial wraps of fiber 31 about the tube 40, the initial strands 56 that are captured by the hook 67 provide an optimized and realistic “end” that maximizes the effective length of the fiber 31 wrapped around the tube 40.

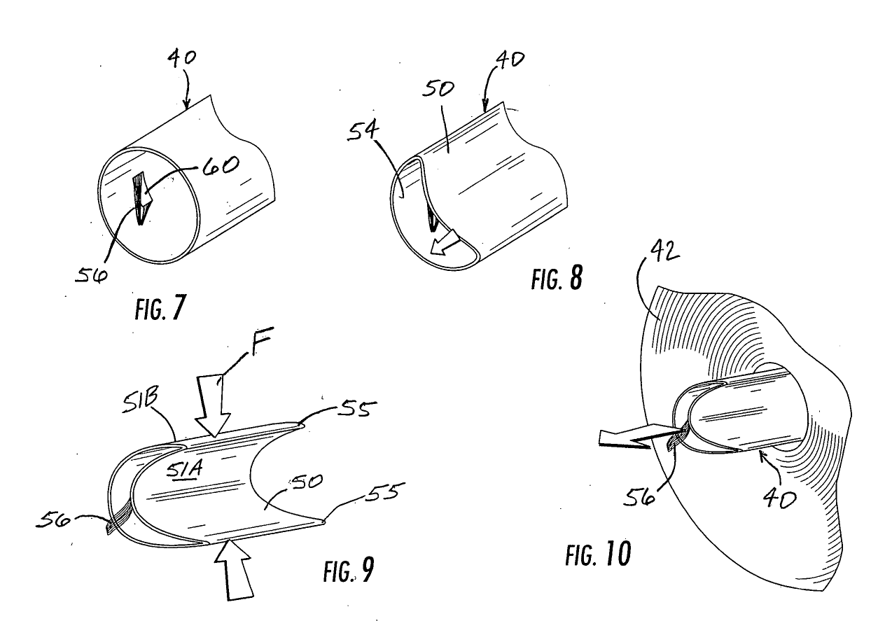

FIGS. 7-10 illustrate various method steps of removing a forming tube from a glass fiber cake according to one embodiment of the present invention. In particular, when the initial wraps 56 are pulled through the opening 60 by the tool 66 (not shown for clarity), the tube 40 is collapsed so that the inner surface 54 is pressed toward itself, as shown in FIG. 8. FIG. 9 shows the tube 40 as it is collapsed even further so that the outer surface 50 forms an inner folded surface 51A and an outer folded surface 51B. Compressive forces F are applied proximate the folded ends 55 of the tube 40, such as by pinching the tube together with an operator's hands or by a tool or machine. As such, the effective diameter of the tube 40 is reduced, thus allowing the tube to be removed from the glass fiber cake 42. FIG. 10 illustrates the forming tube 40 being removed from the cake 42, whereby the initial wraps 56 are shown as extending out one end 52 of the tube so that an operator can easily grasp the initial wraps and to locate an end for tying to an adjacent cake or other such process. The process steps shown in FIGS. 7-10 are only one method of removing the tube. Variations in the process steps are contemplated by the present invention, as long as the tube 40 is removed and the initial wraps 56 are captured and retained for connection to an adjacent cake.

Accordingly, the opening 60 provided by the present invention allows an operator to easily locate and capture initial strands or wraps 56 of glass fiber 31 that is wrapped around the forming tube 40 to form a glass fiber cake 42. The positioning and shape of the opening (or openings) 60 allows for easy access to the initial wraps 56 to quickly and easily locate an end of the fiber 31, thereby eliminating unnecessary waste and increasing efficiency in downstream processes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A forming tube for supporting glass fiber, the tube comprising:
an elongate tube formed by a tube wall having opposing ends, an outer surface adapted to have glass fiber wound thereon, an inner surface, and a central opening extending along a longitudinal axis of the tube for receiving a mandrel, the tube wall defining an opening extending therethrough between the inner and outer surfaces thereof and located proximate one of the opposing ends, the opening designed to facilitate access to a start-up portion of the glass fiber from at least the central opening of the tube, the tube being structured and arranged to be collapsible radially inwardly to facilitate withdrawing the tube from a glass fiber cake wound on the tube.

2. A forming tube according to claim 1, wherein the opening is spaced inwardly from one of the opposing ends.

3. A forming tube according to claim 1, wherein the opening begins at one of the opposing ends and extends along the longitudinal axis toward the other opposing end.

4. A forming tube according to claim 1, wherein the tube defines at least one opening at each of the opposing ends thereof.

5. A forming tube according to claim 4, wherein at least one of the openings begins at a corresponding end and extends along the longitudinal axis toward the opposing end.

6. A forming tube according to claim 1, wherein the outer surface of the tube has a water-resistant coating applied thereto.

7. A forming tube according to claim 1, wherein the tube is formed from at least one of the group consisting of paperboard, polymeric, and metallic materials.

8. A forming tube in combination with glass fiber, comprising:
an elongate tube formed by a tube wall having opposing ends, an outer surface adapted to have glass fiber wound thereon, an inner surface, and a central opening extending along a longitudinal axis of the tube for receiving a mandrel;
a strand of glass fiber wound about the outer surface of the tube wall to form a glass fiber cake on the tube, the glass fiber having a start-up portion wound about an end portion of the tube;
wherein said end portion of tube defines an opening extending through the tube wall between the inner and outer surfaces thereof, and the start-up portion of the glass fiber traverses the opening such that the start-up portion can be accessed through said opening from the central opening of the tube, and wherein the tube is structured and arranged to be collapsible radially inwardly to facilitate withdrawing the tube from the glass fiber cake wound on the tube.

9. A forming tube according to claim 8, wherein the opening is spaced inwardly from one of the opposing ends.

10. A forming tube in combination with glass fiber according to claim 9, wherein the opening is positioned under the glass fiber cake.

11. A forming tube in combination with glass fiber according to claim 8, wherein the opening begins at one of the opposing ends and extends along the longitudinal axis toward the other opposing end.

12. A forming tube in combination with glass fiber according to claim 8, wherein the tube defines an opening at each of the opposing ends thereof.

13. A forming tube in combination with glass fiber according to claim 12, wherein at least one of the openings begins at a corresponding end and extends along the longitudinal axis toward the opposing end.

14. A forming tube in combination with glass fiber according to claim 8, wherein the outer surface of the tube has a water-resistant coating applied thereto.

15. A forming tube in combination with glass fiber according to claim 8, wherein the tube is formed from at least one of the group consisting of paperboard, polymeric, and metallic materials.

16. A method of removing a forming tube from a glass fiber cake, the method comprising the steps of:
accessing a start-up portion of glass fiber of the glass fiber cake through an opening in a wall of the forming tube located proximate one end of the tube;
capturing the start-up portion of glass fiber by extending a tool into the opening; and
removing the tube from the glass fiber cake so that the start-up portion of glass fiber extends away from the glass fiber cake and is thereby readily identifiable.

17. A method according to claim 16, wherein the accessing step includes visually identifying the start-up portion of glass fiber.

18. A method according to claim 16, wherein the capturing step includes pulling the start-up portion through the opening into a central opening defined by the tube.

19. A method according to claim 16, further comprising collapsing at least a portion of the tube to assist with removal of the tube from the glass fiber cake.

20. A method according to claim 16, wherein the removing step includes pulling the start-up portion through the opening and holding the start-up portion in place while removing the tube from the glass fiber cake.
